(19) United States
(12) Patent Application Publication
(10) Pub. No.: US 2009/0276675 A1
(43) Pub. Date: Nov. 5, 2009

(54) SIGNALING OF REDUNDANCY VERSION AND NEW DATA INDICATION

(76) Inventors: Jussi Ojala, Helsinki (FI); Frank Frederiksen, Klarup (DK); Asbjorn Grovlen, Frederiksberg (DK); Lars Lindh, Helsingfors (FI); Esa Malkamaki, Espoo (FI)

Correspondence Address: BRAKE HUGHES BELLERMANN LLP, c/o CPA Global, P.O. BOX 52050, MINNEAPOLIS, MN, 55402, US

(21) Appl. No.: 12/433,478

(22) Filed: Apr. 30, 2009

Related U.S. Application Data
(60) Provisional application No. 61/050,609, filed on May 5, 2008.

(51) Int. Cl. H04L 1/18; G06F 11/14; G06F 11/10; H04W 72/04

(52) U.S. Cl. 714/749; 370/329; 714/752; 714/790; 714/748; 714/E11.113; 714/E11.032

(57) ABSTRACT

Example methods and apparatus for communicating encoded data blocks in wireless communication systems are disclosed. In one example embodiment, a method for receiving an encoded data block includes receiving a data transmission including a subset of a plurality of bits of the encoded data block. The example method also includes receiving a first control signal indicating whether the received subset is a first received subset associated with the encoded data block or whether one or more subsets were previously received for the encoded data block. The example method also further includes receiving a second control signal, the second control signal having a first state and a second state. In the example method, the first state of the second control signal indicates that the received subset includes a first predefined subset of the plurality of bits of the encoded data block and the second state of the second control signal indicates that the received subset includes one of a plurality of other predefined subsets of the plurality of bits of the encoded data block. In this example embodiment, determining which of the other predefined subsets is included in the received subset is based on one or more system parameters of the wireless communication system. Further in this example, the state of the second control signal is selectable between its first state and its second state on a data transmission by data transmission basis, regardless of whether or not one or more subsets of the encoded data block were previously received.

### CROSS REFERENCE TO RELATED APPLICATIONS

This application claims priority based on U.S. Provisional Application No. 61/050,609, filed on May 5, 2008, entitled, “SIGNALING OF REDUNDANCY VERSION AND NEW DATA INDICATION,” the disclosure of which is hereby incorporated by reference.

### TECHNICAL FIELD

This description relates to wireless networks.

### BACKGROUND

When data (e.g., packet data, which may be voice or user data) is communicated in a wireless telecommunications system, signal interference and/or noise may cause errors in such transmissions. The lower the ratio of the strength of a data signal (e.g., a modulated signal used to wirelessly communicate such data) to the strength of any noise and/or interference in a radio channel (i.e., a Signal to Noise and Interference Ratio (SNIR)), the more likely it is that errors will occur in a given transmission.

In order to detect and/or correct such errors in data transmissions, a set of data bits (e.g., user data bits or systematic bits, hereafter “systematic bits”) may be coded to generate parity bits (e.g., error detection bits, cyclic redundancy check bits) and/or error correction codes (e.g., forward error correction (FEC) codes) prior to transmission. The bits produced by such coding may be termed redundant bits, as they are encoded versions of the systematic bits (e.g., “useful” bits) and may be sent along with the systematic bits for use in error detection and/or correction. In some approaches, error detection bits (e.g., CRC bits) are, from an error correction coding point of view, treated as systematic bits (e.g., CRC bits in addition to the user data bits may be treated as systematic bits for purposes of forward error correction (FEC) coding).

Generally speaking, by increasing the number of redundant bits, the likelihood of being able to detect and correct any errors introduced to a given transmission also increases. However, increasing the number of redundant bits also increases the transmission overhead for systematic bits by reducing the coding rate. Coding rate is generally defined as a ratio of the number of useful bits to the number of total bits (i.e., the number of data bits plus the number of redundant bits). Therefore, there may be a tradeoff made between the number of redundant bits and the benefits of additional redundancy.

Also, when communicating data in a wireless communication system, the number of data bits (or data symbols) allocated for each transmission in a radio channel may be less than a total number of bits (or data symbols) of an encoded data block (i.e., the systematic bits plus the redundant coded bits) that is to be transmitted. Accordingly, in such a situation, only a fraction (subset) of the total number of bits of an encoded data block may be communicated in a single transmission opportunity. One such technique for transmitting an encoded data block in such a situation is the use of one or more (e.g., eight) Hybrid Automatic Repeat-Request (processes) per radio channel. In such embodiments, Multiple HARQ processes may be used to account for processing delays (e.g., coding delays) and propagation delays (e.g., transmission time) and to provide a constant stream of data in a given radio channel.

In such an approach (e.g., HARQ), various redundancy versions (RVs) of the encoded data block may be sent from a sending node to a receiving node. RVs may be different predefined subsets (punctures) of the entire bit field of an encoded data block. For instance, an RV=0 transmission may include all the systematic bits of an encoded data block and a subset of the redundant, coded bits (e.g., error detection bits and/or error correction codes). An RV=1 transmission may include only a subset of the redundant bits and an RV=2 transmission may include the systematic bits and a different subset of redundant bits than the RV=0 transmission.

Thus, in the above scenario, if multiple RVs are received and combined, a coding gain may be realized. Depending on the particular embodiment, such a coding gain may provide an effective 5 dB increase in the SNIR for such data transmissions. Accordingly, transmission energy in such embodiments may be reduced relative to embodiments where such coding gains are not realized.

In communication systems that implement HARQ functionality using RVs, a receiving node (e.g., mobile device) is informed of a RV of a given data transmission and is informed whether to combine information included in the data transmission with data that is already saved in an associated HARQ buffer, or if the HARQ buffer should be flushed before storing the data from the RV. In such approaches, data transmissions are combined or stored in the HARQ buffer based on a puncture matrix that corresponds with the RVs of the various data transmissions. The HARQ buffers are flushed based on whether a data transmission is associated with a new encoded data block (e.g., no previous RVs have been received). In such approaches, a New Data Indicator (NDI) may be used to indicate that a respective HARQ buffer should be flushed prior to storing a puncture included in an associated data transmission. Also, an RV indicator may be used to indicate which RV (puncture) is included in a given transmission.

Current approaches, however, have certain drawbacks. For instance, the NDI and RV indicator may be transmitted in a radio link control channel. Such control channels typically have very limited bandwidth. In certain embodiments, the RV indicator is signaled using multiple bits. Thus, reducing the number of bits used to signal RVs is desirable, so as to free up bandwidth in an associated control channel. In other approaches, sending nodes cannot retransmit an RV=0 transmission on their own initiative. The ability to retransmit an RV=0 transmission on a sending node's own initiative may be advantageous in situations where a negative acknowledgement was received (e.g., an uncorrectable error was introduced into a previous RV=0 transmission). Additionally, the ability to retransmit an RV=0 transmission on a sending node's own initiative may also be advantageous in situations where no acknowledgment (e.g., positive or negative) is received in response to an earlier RV=0 transmission.

### SUMMARY

In an example embodiment, a method for receiving an encoded data block in a wireless communication system may include receiving a data transmission including a subset of a plurality of bits of the encoded data block. The example method may also include receiving a first control signal indicating whether the received subset is a first received subset associated with the encoded data block or whether one or more subsets were previously received for the encoded data block. The example method may also further include receiving a second control signal, the second control signal having a first state and a second state.

In the example method, the first state of the second control signal may indicate that the received subset includes a first predefined subset of the plurality of bits of the encoded data block and the second state of the second control signal may indicate that the received subset includes one of a plurality of other predefined subsets of the plurality of bits of the encoded data block. In this example embodiment, determining which of the other predefined subsets is included in the received subset may be based on one or more system parameters of the wireless communication system. Further in this example, the state of the second control signal may be selectable between its first state and its second state on a data transmission by data transmission basis, regardless of whether or not one or more subsets of the encoded data block were previously received.

In another example embodiment, a method for transmitting an encoded data block in a wireless communication system may include transmitting a data transmission including a subset of a plurality of bits of the encoded data block. The example method may also include transmitting a first control signal indicating whether the transmitted subset is a first transmitted subset associated with the encoded data block or whether one or more subsets were previously transmitted for the encoded data block. The example method may still further include transmitting a second control signal, the second control signal having a first state and a second state.

In this example, the first state of the second control signal may indicate that the transmitted subset includes a first predefined subset of the plurality of bits of the encoded data block and the second state of the second control signal may indicate that the transmitted subset includes one of a plurality of other predefined subsets of the plurality of bits of the encoded data block. In this example, determining which of the other predefined subsets is included in the received subset may be based on one or more system parameters of the wireless communication system. Still further, in this example embodiment, the state of the second control signal may be selectable between its first state and its second state on a data transmission by data transmission basis, regardless of whether or not one or more subsets of the encoded data block were previously transmitted.

In yet another example embodiment, an apparatus includes a controller, a wireless transceiver operationally coupled with the controller, and a memory operationally coupled with the controller. In the example apparatus, the controller, wireless transceiver and memory may be collectively configured to receive a data transmission including a subset of a plurality of bits of the encoded data block. In this embodiment, the controller, wireless transceiver and memory may be collectively further configured to receive a first control signal indicating whether the received subset is a first received subset associated with the encoded data block or whether one or more subsets were previously received for the encoded data block. In this example apparatus, the controller, wireless transceiver and memory may be collectively also configured to receive a second control signal, the second control signal having a first state and a second state.

In this embodiment, the first state of the second control signal may indicate that the received subset includes a first predefined subset of the plurality of bits of the encoded data block and the second state of the second control signal may indicate that the received subset includes one of a plurality of other predefined subsets of the plurality of bits of the encoded data block. In the example apparatus, determining which of the other predefined subsets is included in the received subset may be based on one or more system parameters of the wireless communication system. Still further in the apparatus, the state of the second control signal may be selectable between its first state and its second state on a data transmission by data transmission basis regardless of whether or not one or more subsets of the encoded data block were previously received.

In still yet another example embodiment, an example apparatus may include a controller, a wireless transceiver operationally coupled with the controller, and a memory operationally coupled with the controller. In the example apparatus, the controller, wireless transceiver and memory may be collectively configured to transmit a data transmission including a subset of a plurality of bits of the encoded data block. The controller, wireless transceiver and memory may be collectively further configured to transmit a first control signal indicating whether the transmitted subset is a first transmitted subset associated with the encoded data block or whether one or more subsets were previously transmitted for the encoded data block. In this example, the controller, wireless transceiver and memory may be collectively also configured to transmit a second control signal, the second control signal having a first state and a second state.

In this example, the first state of the second control signal may indicate that the transmitted subset includes a first predefined subset of the plurality of bits of the encoded data block and the second state of the second control signal may indicate that the transmitted subset includes one of a plurality of other predefined subsets of the plurality of bits of the encoded data block. Still further in this example, determining which of the other predefined subsets is included in the received subset may be based on one or more system parameters of the wireless communication system. Also in the example apparatus, the state of the second control signal may be selectable between its first state and its second state on a data transmission by data transmission basis, regardless of whether or not one or more subsets of the encoded data block were previously transmitted.

The details of one or more example embodiments are set forth in the accompanying drawings and the description below. Other features will be apparent from the description and drawings, and from the claims.

### BRIEF DESCRIPTION OF THE DRAWINGS

FIG. 1 is a block diagram illustrating an example embodiment of a wireless network.

FIG. 2 is a flowchart illustrating an example embodiment of a method for receiving an encoded data block.

FIG. 3 is a flowchart illustrating another example embodiment of a method for receiving an encoded data block.

FIG. 4 is a flowchart illustrating yet another example embodiment of a method for receiving an encoded data block.

FIG. 5 is a flowchart illustrating still yet another example embodiment of a method for receiving an encoded data block.

FIG. 6 is a diagram illustrating an example embodiment of a downlink control information message.

FIG. 7 is a diagram illustrating an example embodiment of a Hybrid Automatic Repeat-Request (HARQ) buffer.

FIG. 8 is a block diagram illustrating an example embodiment of a sending node and a receiving node that may be used to communicate an encoded data block.

FIG. 9 is a diagram illustrating an example embodiment of an equation for determining a Redundancy Version.

FIG. 10 is a flowchart illustrating an example embodiment of a method for transmitting an encoded data block.

FIG. 11 is a flowchart illustrating another example embodiment of a method for transmitting an encoded data block.

FIG. 12 is a flowchart illustrating yet another example embodiment of a method for transmitting an encoded data block.

FIG. 13 is a flowchart illustrating still yet another example embodiment of a method for transmitting an encoded data block.

FIG. 14 is a block diagram illustrating an example embodiment of a wireless communication device.

### DETAILED DESCRIPTION

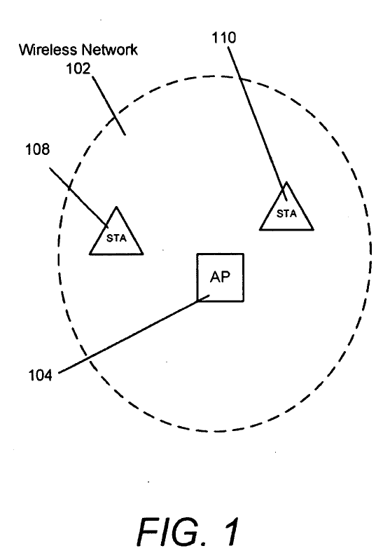

FIG. 1 is a block diagram illustrating a wireless network 102. The wireless network 102 may include an Access Point (AP) 104 and mobile stations (mobile devices) (STAs) 108 and 110. The AP 104 may take the form of a cellular communication base station, for example, or may take the form of any wireless communication access point, such as a wireless router, for example. The STAs 108 and 110 may take the form of cellular communication mobile devices, such as cellular phones, wireless personal digital assistants, or any other appropriate wireless communication devices. The AP 104 and the STAs 108 and 110 may communicate with each other using any number of radio access protocols, such as, for example, the Evolved Universal Mobile Telecommunications System (UMTS) Terrestrial Radio Access Network (E-UTRAN) standards.

In the wireless network 102, encoded data blocks may be transmitted between the AP 104 and the STAs 108 and 110. Such communication of encoded data blocks may be accomplished in the network 102 using Hybrid Automatic Repeat-Request (HARQ) processes, including signaling of a New Data Indicator (NDI) and a Redundancy Version (RV), such as illustrated by, for example, the various example embodiments described herein.

It will be appreciated that, in one example embodiment, an encoded data block may be communicated from the AP 104 to one of the STAs 108 and 110, while in another example embodiment, an encoded data block may be communicated from one of the STAs 108 and 110 to the AP 104. It will also be appreciated that the embodiments described herein are given only by way of example and numerous other arrangements may be possible.

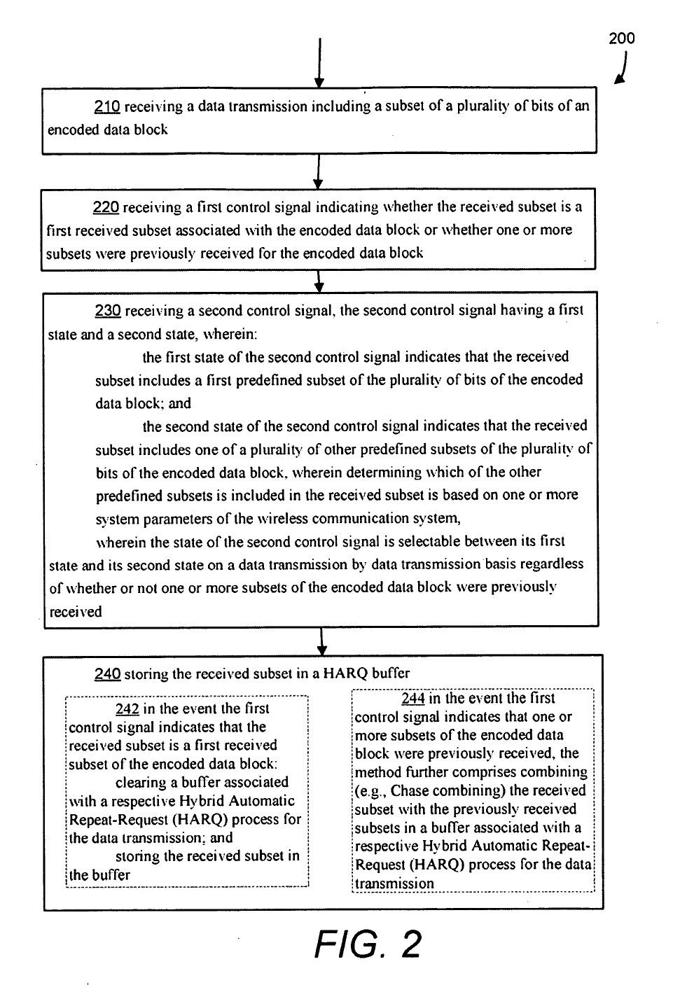

FIG. 2 is a flowchart illustrating an example embodiment of a method 200 for receiving an encoded data block in a wireless communication system. As noted above, in an example embodiment, the encoded data block may be communicated from a base station to a mobile device, or vice versa.

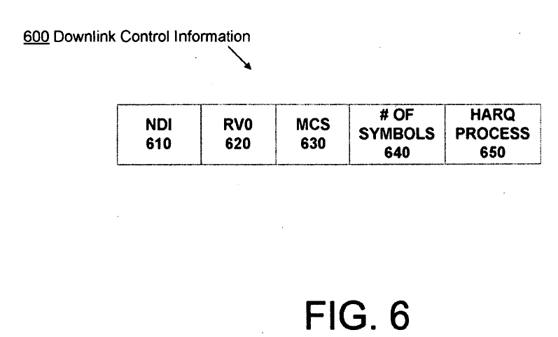

The method 200, at block 210, includes receiving a data transmission including a subset of a plurality of bits of the encoded data block. In an example embodiment, the received subset may correspond with one of a plurality of redundancy versions (RVs) for the encoded data block. Example embodiments of such data transmissions corresponding with a plurality of example RVs are described in further detail below with respect to FIGS. 6-9, for example.

The method 200 also includes, at block 220, receiving a first control signal, where the first control signal may indicate whether the received subset is a first received subset associated with the encoded data block, or whether one or more subsets were previously received for the encoded data block. In an example embodiment, the first control signal may be a New Data Indicator (NDI) signal, which may be a differentially coded single-bit signal that changes state for each new encoded data block to be transmitted. Further, in an example embodiment, the first control signal may have a predefined state for a first data transmission (e.g., a first data transmission of a newly started HARQ process).

The method 200, at block 230, may further include receiving a second control signal, where the second control signal may have a first state and a second state. In an example embodiment, the second control signal may be a single-bit RV0 signal. In such an approach, the RV0 signal being set to logic high may indicate that an associated data transmission includes an RV=0 puncture, such as is described in further detail below. Further, in such an approach, the RV0 signal being set to logic low may indicate that a device receiving an associated data transmission should determine a corresponding RV based on one or more system parameters, such as using the techniques described herein, for example. In an example embodiment, the NDI signal and the RV0 signal may operate in accordance with the Evolved Universal Mobile Telecommunications System (UMTS) Terrestrial Radio Access Network (E-UTRAN) standards/specifications.

In the method 200, the second control signal (e.g., RV0) is selectable between its first state and its second state on a data transmission by data transmission basis, regardless of whether or not one or more subsets of the encoded data block were previously received. For instance, a device that is sending an encoded data block may send, for example, an RV=0 data transmission (puncture) on its own initiative at any given transmission opportunity. Using such an approach may be advantageous in embodiments where there is a significant amount of noise or interference, as the sending node may resend the same set of bits (e.g., including the user data bits or systematic bits) using a less aggressive modulation technique (e.g., less bits per symbol) or, alternatively, using increased transmission energy.

The method 200, at block 240, may further include storing the received subset in a buffer, such as in a buffer associated with a corresponding HARQ process of which the data transmission is part of. Depending on the state of the first control signal (e.g., NDI) and the second control signal (e.g., RV0), different approaches for storing the received subset may be implemented.

For instance, in the event that the first control signal (NDI) indicates that the received subset is a first received subset of the encoded data block (e.g., the encoded data block is a new encoded data block), the method 200 may include, at block 242, clearing a buffer associated with a respective Hybrid Automatic Repeat-Request (HARQ) process for the data transmission; and storing the received subset in the buffer after it is cleared.

In the event the first control signal (NDI) indicates that one or more subsets of the encoded data block were previously received, the method 200 may include, at block 244, combining the received subset with any previously received subsets in a respective HARQ buffer associated with the data transmission. In an example embodiment, such combining may be accomplished using Chase combining.

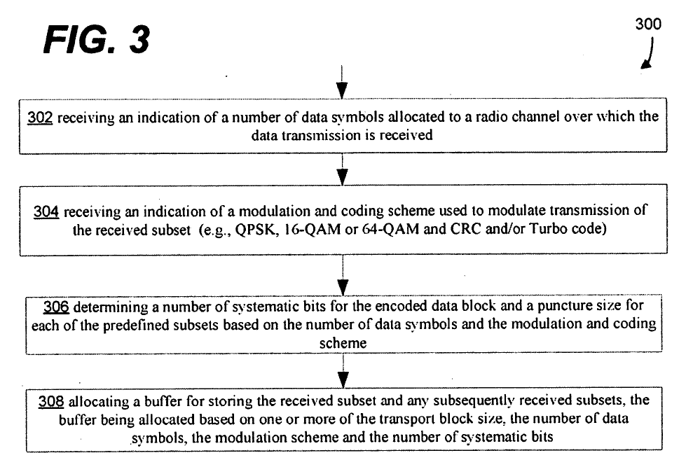

FIG. 3 is a block diagram illustrating another example method 300 for receiving an encoded data block. The method 300 includes, at block 302, receiving an indication of a number of data symbols allocated to a radio channel over which a data transmission is received, where the data transmission includes a subset of a plurality of bits of an encoded data block. The method 300 also includes, at block 304, receiving an indication of a modulation and coding scheme used to modulate transmission of the received subset. At block 306, the method 300 includes determining a transport block size and a number of systematic bits for the encoded data block. The method also includes, at block 306, determining a puncture size for each of the predefined subsets. The transport block size, the number of systematic bits and the puncture size may be determined based on the number of data symbols and the modulation and coding scheme indicated at block 302 and 304, respectively.

The method 300 still further includes, at block 310, allocating a buffer (e.g., in a memory of a wireless device receiving the data transmission) for storing the received subset and any subsequently received subsets. In the method 300, the buffer may be allocated based on one or more of the transport block size, the number of data symbols, the modulation and coding scheme and the number of systematic bits.

In the method 300, the indication of the modulation and coding scheme at block 304 may include an indication that the data transmission is modulated in accordance with one of Quadrature Phase Shift Keying (QPSK), 16-Quadrature Amplitude Modulation (16-QAM) and 64-QAM. Further, the indication at block 304 may indicate that coding is done using cyclic redundancy check coding and Turbo coding, for example.

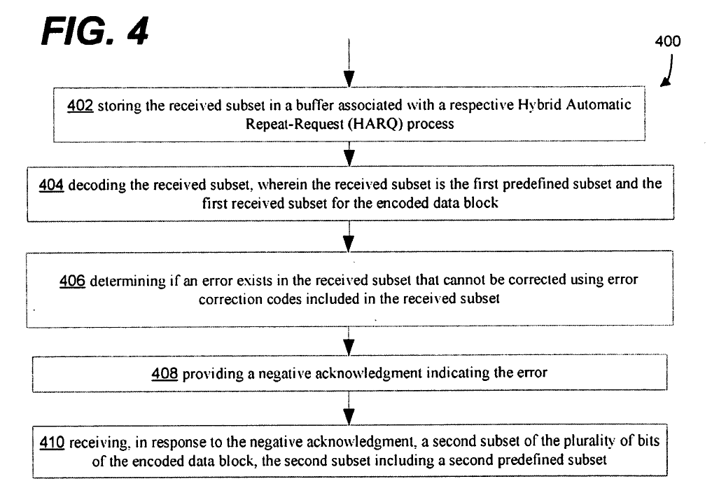

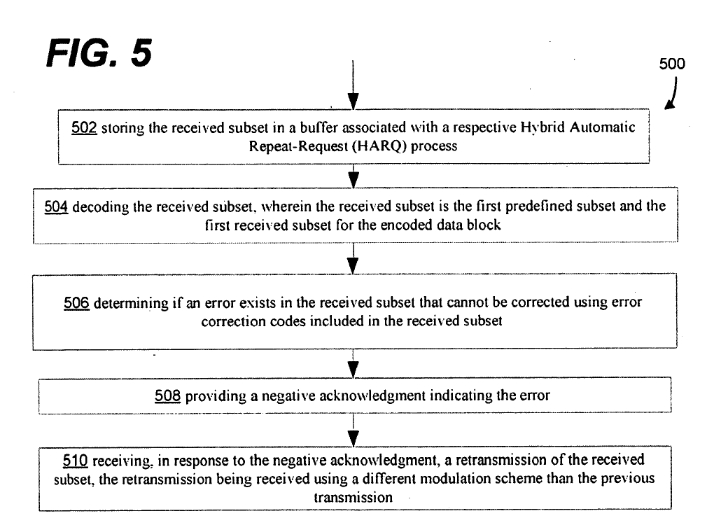

FIGS. 4 and 5 are flowcharts illustrating two other example methods 400 and 500, respectively, for receiving an encoded data block. The operations in blocks 402-408 of FIG. 4 are the same as the operations in blocks 502-508 of FIG. 5. Thus, for purposes of brevity, the operations 402-408 and 502-508 will be discussed together and separate discussion of operations 410 and 510 will follow.

In the methods of FIGS. 4 and 5, at blocks 402 and 502, the methods may include storing a received subset (e.g., an RV puncture of an encoded data buffer) in a buffer associated with a respective Hybrid Automatic Repeat-Request (HARQ) process. The methods, at blocks 404 and 504, may further include decoding the received subset. In the methods 400 and 500, the received subset may be a first predefined subset (e.g., an RV=0 data transmission) for an encoded data block. Furthermore, in the methods 400 and 500, the first received subset for the encoded data block may be the first subset received (e.g., new encoded data block) for an encoded data block. At blocks 406 and 506, the example methods may include determining if an error exists in the received subset (e.g., using error detection code and/or CRC) that cannot be corrected using error correction codes included in the received subset. In the event such an error is present, the methods then include, at blocks 408 and 508 respectively, providing a negative acknowledgment indicating the error.

At block 410, the method 400 may include receiving, in response to the negative acknowledgment, a second subset of the plurality of bits of the encoded data block, the second subset may include a second predefined subset (e.g., another RV puncture). At block 510, the method 500 may include receiving, in response to the negative acknowledgment, a retransmission of the received subset (e.g., the RV=0 puncture), where the retransmission may be received using a different modulation scheme than the previous transmission. For instance, at block 510, the modulation scheme may be changed to reduce the number of bits per symbol in order to compensate for noise and/or interference in an associated radio channel.

FIG. 6 is a diagram illustrating Downlink Control Information (DCI) 600 that may be used to communicate (e.g., via a radio link control channel) information regarding HARQ processes from a sending node (e.g., a base station) to a receiving node (e.g., a mobile device). In another example embodiment, substantially similar information may be included as part of Uplink Control Information (UCI) when a mobile device is transmitting an encoded data block to a base station, as an example.

In this particular embodiment, which is given by way of example for purposes of illustration, the DCI 600 includes an NDI signal 610, which may be a differentially coded single-bit signal, such as described above. The DCI 600 may also include an RV0 indicator. The RV0 indicator may be a single-bit signal that may operate in like fashion as previously described (i.e., indicates that an associated data transmission includes an RV=0 puncture when RV0 is logic high; and indicates that the receiving device should determine the RV of an associated data transmission based on one or more system parameters, such as using the techniques described herein, when RV0 is logic low. In another example embodiment, setting RV0 to logic low may indicate that RV=0.

The DCI 600 also includes a modulation and coding scheme field 630 that may be used to indicate a modulation scheme (e.g., QPSK, 16-QAM or 64-QAM) and a coding scheme (e.g., error correction coding) that are used for an associated data transmission. The example DCI 600 may also include an indication of a number of (data or channel) symbols 640 that are allocated to an associated radio channel. Based on the MCS 630 and the number of symbols 640, a receiving device for an associated data transmission may determine a transport block size and a puncture matrix corresponding with an encoded data block being transmitted.

The DCI 600 also includes a HARQ process indicator 650. The HARQ processor indicator 650 may be used to associate a given data transmission with an respective HARQ process of a radio channel, so that HARQ buffer flushing and/or data combination for each of the HARQ processes operating in an associated radio channel may be accurately carried out. It will be appreciated that the information included in the DCI 600 is shown by way of example. The information included in the DCI 600 may be communicated in other control messages or over other channels of a radio link, e.g., other than a control channel. In an example, embodiment, the information included in the DCI 600 may change. For uplink control information (UCI), the HARQ process number is typically not transmitted since synchronous HARQ operation may be assumed in uplink and the HARQ process number (or id) can be derived from a subframe number or a transport time interval count.

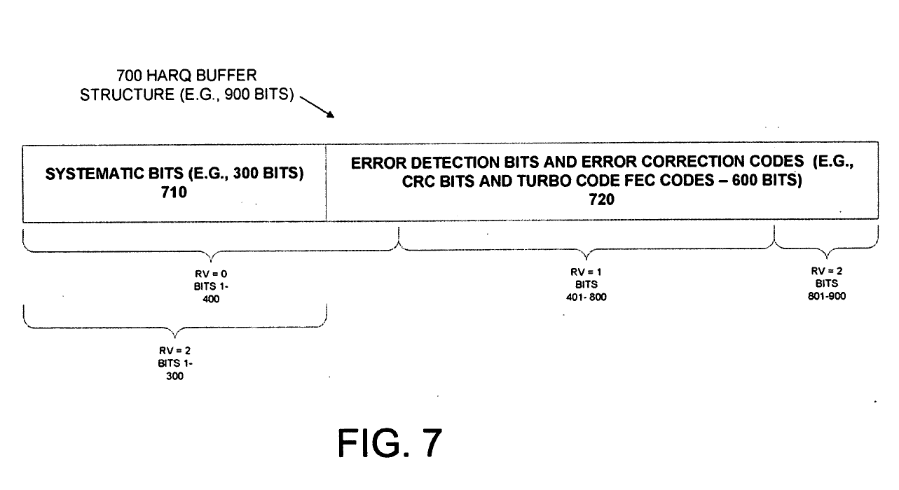

FIG. 7 is a diagram illustrating an example embodiment of a buffer 700 that may be used as a HARQ buffer to store bits of an encoded data block (e.g., in accordance with a plurality of predefined RVs) when received as part of a HARQ process. The structure of the buffer 700 may also be used in a wireless device that is transmitting the encoded data block. In such an approach, the encoded data block may be stored in the buffer 700 while it is being transmitted as part of a HARQ process. Once the transmitting device receives a positive acknowledgment from a corresponding receiving device, the encoded data block stored in the transmitting device may be discarded and replaced with a new encoded data block for transmission.

In an example embodiment, the buffer 700 may be used for receiving encoded data blocks of 900 bits, where the encoded data block includes 300 systematic bits 710 and 600 bits for error detection bits and/or error correction bits 720 (collectively “error correction bits 720”). In such an example, the code rate of such an encoded data block would be 1/3 (e.g., the encoded data block includes 300 user data bits and 900 total bits with the 600 redundant error correction bits 720). In an example embodiment, the error correction bits 720 may include cyclic redundancy check (CRC) bits and Forward Error Correction (FEC) codes. Depending on the particular embodiment, the FEC codes may be produced in accordance with a Turbo code. Turbo codes are known to those working in this area and will not be described in detail here.

In some embodiments, error detection bits (e.g., CRC bits) may be treated as systematic bits. Thus, in such an approach, the 300 systematic bits (710) may include, e.g., 276 user data bits and 24 CRC bits, for which 600 error correction (or parity, or redundancy) bits are generated using Turbo coding. In this situation, the Turbo code rate is 1/3.

For a radio link that is able to communicate 400 bits per transmission opportunity (e.g., a radio channel using 16-QAM with 100 data symbols allocated to the channel), an RV=0 data transmission (puncture) corresponding with the buffer 700 of FIG. 7 may include the systematic bits 710 and 100 of the error correction bits 720 (e.g., bits 1-400 of the buffer 700). For the same radio link, an RV=1 data transmission (puncture) corresponding with the buffer 700 may include 400 of the error correction bits 720 (e.g., bits 401-800 of the buffer 700), as shown in FIG. 7. Further for this example, an RV=2 data transmission (puncture) corresponding with the buffer 700 may again include the systematic bits 710 (bits 1-300) and also may include the remaining 100 error correction bits 720 not included in the RV=0 and RV=1 data transmissions (punctures), e.g., bits 801-900 of the buffer 700. Such RVs and HARQ buffer configuration may be implemented, for example, in accordance with the E-UTRAN specifications.

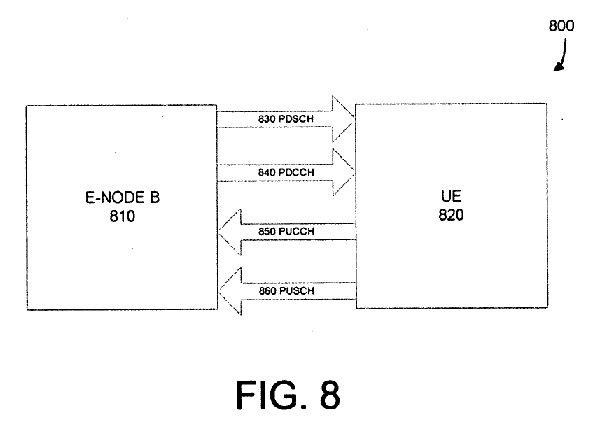

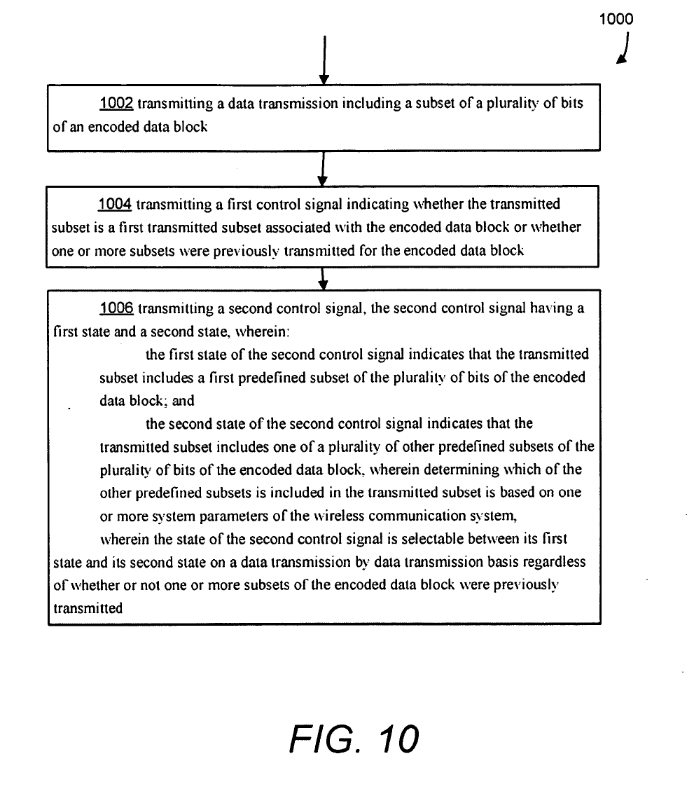

FIG. 8 is a block diagram illustrating an example embodiment of an active radio channel 800 that may be used to communicate an encoded data block using the techniques descried herein. The active radio channel 800 includes a transmitting device, Evolved-Node B (eNodeB) 810, which may be a wireless communication base station that operates in accordance with the E-UTRAN specifications. The active radio channel 800 also includes a receiving device, User Equipment (UE) 820, which may be a mobile device that operates in accordance with the E-UTRAN specifications. In an example embodiment, the E-NodeB 810 may implement the operations of a transmitting device, such as those included in the methods discussed below with respect to FIGS. 10-13, while the UE 820 may implement the operations of a receiving device, such as those included in the methods discussed above with respect to FIGS. 2-5. For uplink traffic in such an arrangement, eNodeB 810 may act as a receiver and the UE 820 may act as a transmitter.

As shown in FIG. 8, the active radio link 800 further includes a Physical Downlink Shared Channel (PDSCH) 830 that may be used to communicate the data transmission (e.g., the systematic bits and/or redundant bits). The active radio channel 800 also includes a Physical Downlink Control Channel 840, which may be used to communicate the first control signal and the second control signal, such as, e.g., part of the DCI 600 shown in FIG. 6 and discussed above.

Alternatively, if a data transmission is being communicated from the UE 820 to the E-NodeB 810, the first and second control signals may be communicated via a Physical Uplink Control Channel (PUCCH), 850 and the data transmission may be communicated via a Physical Uplink Shared Channel (PUSCH) 860. Alternatively, as in the E-UTRAN standards, the control signals (NDI and RV, as well as MCS and physical resource allocations or a number of symbols) may be communicated via a Physical Downlink Control Channel (PDCCH) (e.g., UCI 600 may be sent on PDCCH). In an example embodiment, the PDSCH, the PDCCH, the PUCCH and the PUSCH 860 are implemented in accordance with the E-UTRAN standards/specifications.

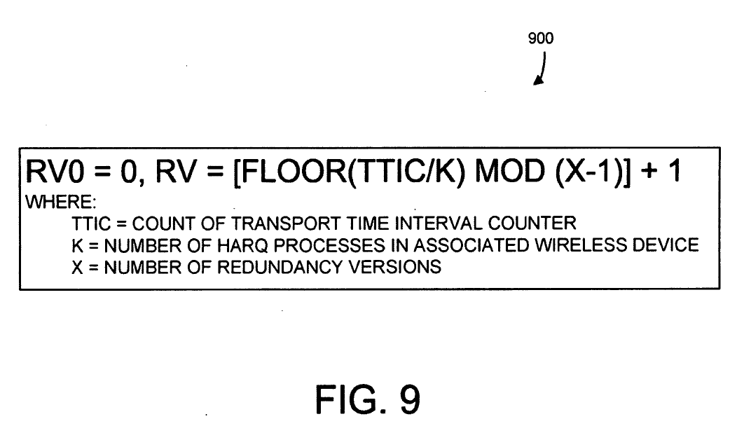

FIG. 9 is a diagram illustrating an equation 900 that may be used to determine an associated redundancy version for a given data transmission based on one or more system parameters. The equation 900 may be used to determine an RV when an RV0 parameter (e.g., the second control signal in the methods of FIGS. 2 and 10) is logic low or zero (or alternatively RV0 is logic high or one), indicating that the RV does not equal 0. In an example embodiment, the RV may then be determined by Equation 1 below:

RV0=0, RV=[floor(TTIC/K) mod (X−1)]+1 Equation 1

In Equation 1, “floor” is a rounding operation towards negative infinity, TTIC is a count of a Transport Time Interval Counter, K is a number of active HARQ processes for an associated radio channel, and X is the number of redundancy versions used in the radio channel. In E-UTRAN, the TTIC counter may be expressed as a combination of a 10 ms timer that increments every 1 ms and rolls over after being incremented 10 times and a system frame number (SFN), which sequentially tracks transmitted frames. The SFN may increment each time the interval counter rolls over. Thus, the TTIC count may be calculated using Equation 2 below:

TTIC=(SFN*10)+Interval Count Equation 2

Alternatively, Interval Count may be replaced with SFN/index, where index has values 0, 1, . . . , 9)

For Equation 1 above, in the case where X=3 (three RVs), the RV values produced will vary between 1 and 2. In the case where X=4 (four RVs), the RV values produced will alternate through the sequence 1, 2 and 3.

In such an approach, in order for a transmitting node to transmit an RV=0 puncture, the transmitting node must set the RV0 parameter to logic high or one. By setting RV0 to a logic high, this indicates that the subset of bits of an encoded data block included in an associated data transmission are an RV=0 puncture of the encoded data block. In this situation, Equation 1 will not be applied to determine the RV, as the RV0 parameter indicates that the RV=0. Such an approach may be advantageous, as is discussed below with respect to FIG. 13.

FIG. 10 is a flowchart illustrating an example embodiment of a method 1000 for transmitting an encoded data block. It is noted that many of the details discussed above with respect to example methods and techniques for receiving an encoded data block may apply equally to transmitting an encoded data block, such as in the methods illustrated in FIGS. 10-13. However, for purposes of brevity and clarity, those details will not be discussed again in detail with respect to transmission of an encoded data block.

The method 1000, at block 1010, includes, transmitting a data transmission including a subset of a plurality of bits of the encoded data block. Such a transmission may be, for example, a RV=0, a RV=1 or a RV=2 data transmission (puncture), such as were previously described. Alternatively, other puncturing techniques may be applied, and the bits included in the transmitted subset may be determined by any appropriate puncturing technique.

The method 1000 further includes, at block 1020, transmitting a first control signal indicating whether the transmitted subset is a first transmitted subset associated with the encoded data block or whether one or more subsets were previously transmitted for the encoded data block. The first control signal of the method 1000 may take the form of a differentially coded NDI signal, such as described above.

The method 1000 may still further include, at block 1030, transmitting a second control signal, the second control signal having a first state and a second state. In the method 1000, the second control signal may be an RV0 control signal, as was discussed above. For instance, the first state (logic high) of the second control signal (RV0) may indicate that the transmitted subset includes a first predefined subset of the plurality of bits of the encoded data block (e.g., an RV=0 puncture). Further, the second state (logic low) of the second control signal (RV0) at block 1020 may indicate that the transmitted subset includes one of a plurality of other predefined subsets of the plurality of bits of the encoded data block (e.g., an RV=1 puncture, or an RV=2 puncture).

In the method 1000, when the second control signal (RV0) is in its second state (e.g., logic low), a RV for a corresponding data transmission may be determined based on one or more system parameters of the wireless communication system, such as discussed above with respect to FIG. 9. Still further, in the method 1000, as in the method 200 above, the state of the second control signal (RV0) may be selectable between its first state and its second state on a data transmission by data transmission basis, regardless of whether or not one or more subsets of the encoded data block were previously transmitted. For instance, a transmitting wireless device may send an RV=0 data transmission (puncture) at any time on its own initiative by setting the state of the second control signal (e.g., RV0) to is its first state (e.g., logic high). As discussed above, such a technique may be advantageous.

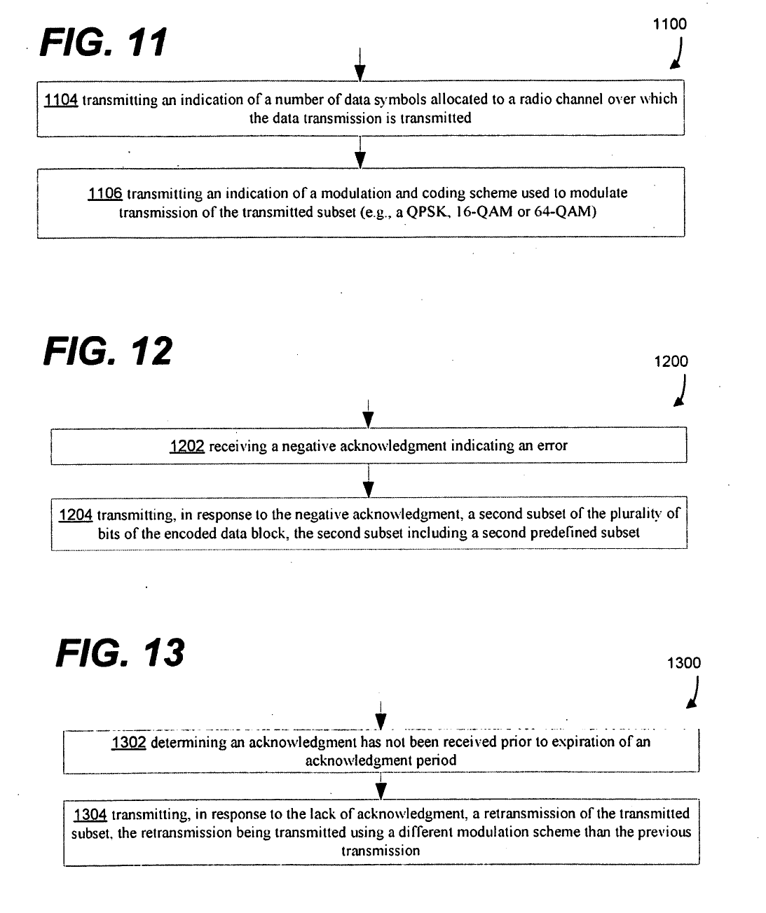

FIG. 11 is a flowchart illustrating another example embodiment of a method 1100 for transmitting an encoded data block. The method 1100, at block 1102, includes transmitting an indication of a number of data symbols allocated to a radio channel over which the data transmission is transmitted. At block 1104, the method 1100 also includes transmitting an indication of a modulation and coding scheme used to modulate transmission of the transmitted subset. As was previously discussed, the modulation scheme may be indicated as, e.g., for E-UTRAN, may be QPSK, 16-QAM or 64-QAM, while the coding scheme may be indicated as including CRC encoding and FEC coding using Turbo coding. As was discussed above, this information may be included in a DCI message or a UCI message. As previously described, the number of data symbols and the modulation and coding scheme may be used to determine a transport block size and define, e.g., a puncture matrix for an associated HARQ buffer in a receiving wireless device.

FIG. 12 is a flowchart illustrating yet another example embodiment of a method 1200 for transmitting an encoded data block. In the method 1200, at block 1202, a wireless communication device that is transmitting an encoded data block may receive a negative acknowledgment indicating that a prior data transmission including one of a predefined set of bits corresponding with one of a plurality of RVs. The negative acknowledgement may indicate to the transmitting wireless device that a corresponding receiving device for the earlier transmission received the earlier data transmission but was unable to correct an error in the received transmission based on the previous transmission alone, or based on the previous transmission in combination with other prior transmissions for the associated encoded data block being transmitted.

At block 1204, in response to the negative acknowledgment, the transmitting wireless node may transmit another subset of the plurality of bits of the encoded data block (e.g., another RV). After transmitting the other subset, the transmitting wireless device may wait for another acknowledgment message from the receiving wireless device. The probability of a positive acknowledgment may be increased as a result of a coding gain associated with transmitting the other RV subset the receiving device, where the other transmitted RV subset may be combined (e.g., Chase combined) with the previous transmission and any other previous transmissions already stored or combined in a corresponding HARQ buffer.

FIG. 13 is a flowchart illustrating still yet another example embodiment of a method 1300 for transmitting an encoded data block. In the method 1300, at block 1302, a wireless communication device may determine that an acknowledgment for a previous data transmission (e.g., a data transmission including an RV=0 data transmission (puncture) for a new encoded data block being transmitted by the wireless device as part of a HARQ process) has not been received. The determination at block 1302 may be based on a timer that is set in the transmitting wireless device. If an acknowledgment is not received (e.g., positive or negative) at the transmitting device before the timer expires, the transmitting device may assume that the earlier transmission was not received at its destination. e.g., the data transmission was lost.

In this situation, at block 1304, the wireless device may transmit, in response to the lack of an acknowledgment, a retransmission of the previously transmitted RV=0 puncture. In the method 1300, at block 1304, the earlier transmitted set of data bits (RV=0) may be being retransmitted using a different modulation scheme than was used for the previous transmission. For example, the modulation scheme may be changed from 16-QAM (4 bits per symbol) to QPSK (2 bits per symbol). Such a change may allow the retransmission to be more tolerant of any noise and/or interference in an associated wireless network and/or radio channel. In this situation, because the wireless device is retransmitting an RV=0 puncture for a new encoded data block, the previous state of an associated NDI signal may be retained, as the receiving device is assumed to not have received the previous transmission and will still recognize the retransmission as being associated with a new encoded data block (e.g., New Data).

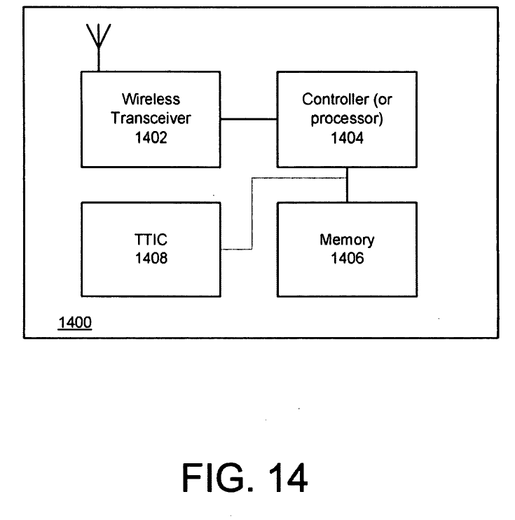

FIG. 14 is a block diagram illustrating a wireless communication apparatus 1400. The apparatus 1400 may include a wireless transceiver 1402. The wireless 1402 transceiver may itself include a wireless transmitter for transmitting radio frequency signals and a wireless receiver for receiving radio frequency signals. Depending on the particular embodiment, either the transmitter or receiver portion may be eliminated.

The apparatus 1400 may also include a controller (or processor) 1404 that is operationally coupled with the wireless transceiver 1402. The controller 1404 may carry out software, hardware and/or firmware instructions in the apparatus 1400. The apparatus 1400 may further include a memory 1406 that is operationally coupled with the controller 1404. The memory 1406 may store information related to the operation of the apparatus 1400, such as program instructions and HARQ buffers (e.g., puncture matrices), for example. As shown in FIG. 14, the apparatus 1400 may also include a TTIC 1408, such as described above, that is operationally coupled with the controller 1404. The TTIC 1408 may be used to determine a redundancy version using, for example, the techniques discussed above. As was also discussed above, the TTIC 1408 may be synchronized with a TTIC count in a corresponding (e.g., sending/receiving wireless device) using any appropriate synchronization procedure, so as to ensure that RV determinations are matched between sending devices and corresponding receiving devices.

In the apparatus 1400, the wireless transceiver 1402, the controller 1404, the memory 1406 and the TTIC 1408 may be collectively configured to receive and/or communicate an encoded data block in accordance with the methods and approaches described above with respect to FIGS. 2-13. For the sake of brevity, the details of those approaches will not be discussed again with respect to FIG. 14.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art.

What is claimed is:

1. A method for receiving an encoded data block in a wireless communication system, the method comprising:
receiving a data transmission including a subset of a plurality of bits of the encoded data block;
receiving a first control signal indicating whether the received subset is a first received subset associated with the encoded data block or whether one or more subsets were previously received for the encoded data block;
receiving a second control signal, the second control signal having a first state and a second state, wherein:
the first state of the second control signal indicates that the received subset includes a first predefined subset of the plurality of bits of the encoded data block; and
the second state of the second control signal indicates that the received subset includes one of a plurality of other predefined subsets of the plurality of bits of the encoded data block, wherein determining which of the other predefined subsets is included in the received subset is based on one or more system parameters of the wireless communication system,
wherein the state of the second control signal is selectable between its first state and its second state on a data transmission by data transmission basis, regardless of whether or not one or more subsets of the encoded data block were previously received.

2. The method of claim 1, wherein the other predefined subsets includes:
a first puncture of the encoded data block, the first puncture including a first subset of at least one of error detection bits and error correction codes of the encoded data block; and
a second puncture of the encoded data block, the second puncture including:
a second subset of at least one of error detection bits and error correction codes of the encoded data block; and
all the systematic data bits of the encoded data block.

3. The method of claim 2, wherein the systematic data bits comprise user data bits of the encoded data block.

4. The method of claim 1, wherein:
the data transmission is received via one of a Physical Downlink Shared Channel (PDSCH) and a Physical Uplink Shared Channel (PUSCH); and
the first control signal and the second control signal are received via one of a respective Physical Downlink Control Channel (PDCCH) and a Physical Uplink Control Channel (PUCCH),
wherein the PDSCH, the PDCCH, the PUCCH and the PUSCH are implemented in accordance with the Evolved Universal Mobile Telecommunications System (UMTS) Terrestrial Radio Access Network (E-UTRAN) specifications.

5. The method of claim 4, wherein the first control signal and the second control signal are included in Downlink Control Information (DCI).

6. The method of claim 1, wherein the first control signal and the second control signal are associated with a respective Hybrid Automatic Repeat-Request (HARQ) process.

7. The method of claim 1, further comprising:
receiving a transport block size associated with the data transmission;
receiving an indication of a number of data symbols allocated to a radio channel over which the data transmission is received;
receiving an indication of a modulation and coding scheme used to modulate transmission of the received subset; and
determining a number of systematic bits for the encoded data block and a puncture size for each of the predefined subsets based on the transport block size, the number of data symbols and the modulation and coding scheme.

8. The method of claim 7, further comprising allocating a buffer for storing the received subset and any subsequently received subsets, the buffer being allocated based on one or more of the transport block size, the number of data symbols, the modulation and coding scheme and the number of systematic bits.

9. The method of claim 7, wherein the modulation scheme comprises one of Quadrature Phase Shift Keying (QPSK), 16-Quadrature Amplitude Modulation (16-QAM) and 64-QAM.

10. The method of claim 1, further comprising:
storing the received subset in a buffer associated with a respective Hybrid Automatic Repeat-Request (HARQ) process;
decoding the received subset, wherein the received subset is the first predefined subset and the first received subset for the encoded data block;
determining an error exists in the received subset that cannot be corrected using error correction codes included in the received subset;
providing a negative acknowledgment indicating the error; and
receiving, in response to the negative acknowledgment, a second subset of the plurality of bits of the encoded data block, the second subset including a second predefined subset.

11. The method of claim 1, further comprising:
storing the received subset in a buffer associated with a respective Hybrid Automatic Repeat-Request (HARQ) process;
decoding the received subset, wherein the received subset is the first predefined subset and the received subset is the first received subset for the encoded data block;
determining an error exists in the received subset that cannot be corrected using error correction codes included in the received subset;
providing a negative acknowledgment indicating the error;
receiving, in response to the negative acknowledgment, a retransmission of the received subset, the retransmission being received using a different modulation scheme than the previous transmission.

12. The method of claim 1, wherein, in the event the first control signal indicates that the received subset is a first received subset of the encoded data block, the method further comprises:
clearing a buffer associated with a respective Hybrid Automatic Repeat-Request (HARQ) process for the data transmission; and
storing the received subset in the buffer.

13. The method of claim 1, wherein, in the event the first control signal indicates that one or more subsets of the encoded data block were previously received, the method further comprises combining the received subset with the previously received subsets in a buffer associated with a respective Hybrid Automatic Repeat-Request (HARQ) process for the data transmission.

14. The method of claim 13, wherein combining the received subset with the previously received subsets includes Chase combining the received subset with the previously received subsets in the buffer.

15. The method of claim 1, wherein the one of more system parameters include a value of a Transmit Time Interval Counter (TTIC), the TTIC being incremented on a 1 millisecond basis.

16. The method of claim 15, further comprising, in the event the second control signal indicates the received subset includes one of the plurality of other predefined subsets, determining which of the plurality of other predefined subsets the received subset includes based on the equation:
RV=[floor(TTIC/K) mod (X−1)]+1,
wherein RV indicates a redundancy version, TTIC indicates the value of the TTIC, K indicates a number of Hybrid Automatic Repeat-Request (HARQ) processes operating in an associated wireless device, and X indicates a number of available redundancy versions.

17. A method for transmitting an encoded data block in a wireless communication system, the method comprising:
transmitting a data transmission including a subset of a plurality of bits of the encoded data block;
transmitting a first control signal indicating whether the transmitted subset is a first transmitted subset associated with the encoded data block or whether one or more subsets were previously transmitted for the encoded data block;
transmitting a second control signal, the second control signal having a first state and a second state, wherein:
the first state of the second control signal indicates that the transmitted subset includes a first predefined subset of the plurality of bits of the encoded data block; and
the second state of the second control signal indicates that the transmitted subset includes one of a plurality of other predefined subsets of the plurality of bits of the encoded data block, wherein determining which of the other predefined subsets is included in the received subset is based on one or more system parameters of the wireless communication system,
wherein the state of the second control signal is selectable between its first state and its second state on a data transmission by data transmission basis, regardless of whether or not one or more subsets of the encoded data block were previously transmitted.

18. The method of claim 17, wherein the first control signal is a differentially encoded single-bit signal that changes state when the transmitted subset is associated with a new encoded data block.

19. The method of claim 18, wherein the first control signal has a predefined initial state for a first data transmission.

20. The method of claim 17, wherein the first control signal is a New Data Indicator signal in accordance with the Evolved Universal Mobile Telecommunications System (UMTS) Terrestrial Radio Access Network (E-UTRAN) specifications.

21. The method of claim 17, wherein the second control signal comprises a single-bit signal, the first state of the second control signal comprising a logic high and the second state of the second control signal comprising a logic low.

22. The method of claim 17, wherein the second control signal comprises a redundancy version (RV) indicator in accordance with the Evolved Universal Mobile Telecommunications System (UMTS) Terrestrial Radio Access Network (E-UTRAN) specifications.

23. The method of claim 22, wherein the first state of the RV indicator indicates that the received subset is an RV=0 subset in accordance with the E-UTRAN specifications.

24. The method of claim 22, wherein the other predefined subsets include:
an RV=1 subset in accordance with the E-UTRAN specifications; and
an RV=2 subset in accordance with the E-UTRAN specifications.

25. The method of claim 17, wherein the first predefined subset includes a first puncture of the encoded data block, the first puncture including:
all systematic data bits of the encoded data block; and
a first subset of at least one of error detection bits and error correction codes of the encoded data block.

26. The method of claim 17, wherein the encoded data block includes:
a plurality of systematic data bits;
a plurality of cyclic redundancy check (CRC) bits; and
a plurality of forward error correction (FEC) bits.

27. The method of claim 26, wherein the FEC bits are generated using Turbo coding.

28. The method of claim 17, wherein the first control signal and the second control signal are included in one of Downlink Control Information (DCI) and Uplink Control Information (UCI).

29. The method of claim 17, further comprising:
transmitting a transport block size associated with the data transmission;
transmitting an indication of a number of data symbols allocated to a radio channel over which the data transmission is transmitted; and
transmitting an indication of a modulation and coding scheme used to modulate transmission of the transmitted subset.

30. The method of claim 17, further comprising:
receiving a negative acknowledgment indicating an error in the data transmission; and
transmitting, in response to the negative acknowledgment, a second subset of the plurality of bits of the encoded data block, the second subset including a second predefined subset.

31. The method of claim 17, further comprising:
determining an acknowledgment has not been received prior to expiration of an acknowledgment period; and
transmitting, in response to the lack of acknowledgment, a retransmission of the transmitted subset, the retransmission being transmitted using a different modulation scheme than the previous transmission.

32. An apparatus comprising:
a controller;
a wireless transceiver operationally coupled with the controller; and
a memory operationally coupled with the controller,
wherein the controller, wireless transceiver and memory are collectively configured to:
receive a data transmission including a subset of a plurality of bits of the encoded data block;
receive a first control signal indicating whether the received subset is a first received subset associated with the encoded data block or whether one or more subsets were previously received for the encoded data block;
receive a second control signal, the second control signal having a first state and a second state, wherein:
the first state of the second control signal indicates that the received subset includes a first predefined subset of the plurality of bits of the encoded data block; and
the second state of the second control signal indicates that the received subset includes one of a plurality of other predefined subsets of the plurality of bits of the encoded data block, wherein determining which of the other predefined subsets is included in the received subset is based on one or more system parameters of the wireless communication system,
wherein the state of the second control signal is selectable between its first state and its second state on a data transmission by data transmission basis, regardless of whether or not one or more subsets of the encoded data block were previously received.

33. An apparatus comprising:
a controller;
a wireless transceiver operationally coupled with the controller; and
a memory operationally coupled with the controller,
wherein the controller, wireless transceiver and memory are collectively configured to:
transmit a data transmission including a subset of a plurality of bits of the encoded data block;
transmit a first control signal indicating whether the transmitted subset is a first transmitted subset associated with the encoded data block or whether one or more subsets were previously transmitted for the encoded data block;
transmit a second control signal, the second control signal having a first state and a second state, wherein:
the first state of the second control signal indicates that the transmitted subset includes a first predefined subset of the plurality of bits of the encoded data block; and
the second state of the second control signal indicates that the transmitted subset includes one of a plurality of other predefined subsets of the plurality of bits of the encoded data block, wherein determining which of the other predefined subsets is included in the received subset is based on one or more system parameters of the wireless communication system,
wherein the state of the second control signal is selectable between its first state and its second state on a data transmission by data transmission basis, regardless of whether or not one or more subsets of the encoded data block were previously transmitted.
